(19) United States
(12) Patent Application Publication
(10) Pub. No.: US 2010/0153383 A1
(43) Pub. Date: Jun. 17, 2010

(54) Method and system for identifying consumers

(75) Inventor: Ruvan Nahum Cohen, New York, NY (US)

Correspondence Address: WARD & OLIVO, SUITE 300, 382 SPRINGFIELD AVENUE, SUMMIT, NJ, 07901, US

(73) Assignee: INNOVIS DATA SOLUTIONS, INC.

(21) Appl. No.: 12/316,676

(22) Filed: Dec. 16, 2008

(51) Int. Cl. G06F 17/30

(52) U.S. Cl. 707/726; 707/E17.005; 707/E17.044

(57) ABSTRACT

The present invention provides a method and system for determining and creating an extended ID file for a consumer located in a database containing a large record of consumers. The system and method utilizes existing historical records located in legacy databases, and through a scoring program to match consumer records, creates an extended identification file that represents a higher probability of a combination of name, address and social security number for a given consumer. The extended identification file may now be utilized by credit bureaus to locate credit history for the given consumer.

### FIELD OF THE INVENTION

This invention relates to the field of database implementation, and more particularly to a method and system configured for providing alternate identifying information for a given consumer through an extended ID file for a given consumer utilizing a database containing information on a large number of consumers.

### BACKGROUND OF THE INVENTION

Often, business or financial entities will offer consumers or individuals credit cards or other goods or services, on credit. Generally, these business or financial entities will require the consumer to provide a sampling of basic identification information, such as name, date of birth, social security number, address, telephone number, driver's license information or other similar type of information (also known as “wallet-type” information). This wallet-type information is utilized by the business or financial entity to obtain a credit history for the given individual/consumer by providing this wallet-type information to one or more credit bureaus (e.g., Experian, Equifax or Transunion). These one or more credit bureaus process the wallet-type information and match it against a General ID set (i.e., standard records that identify an individual by name, social security number and date of birth, or similar types of personal data) through commercially available databases, and in most cases, the credit bureaus provide a credit history report. This credit history report is then used by the business or financial entity to make a decision on whether to grant or withhold credit for the given consumer.

In order to verify and authenticate a consumer, the credit bureau utilizes this wallet-type data and compares it to their consumer credit header data. This consumer credit header data is data that identifies the consumer by one of name history, name variations, address history, former addresses, telephone number, date of birth history, social security number history and similar type of personal data, which is sometimes generated as a result of providing credit history reports. The credit bureau matches the wallet-type data against a consumer credit header data to authenticate the consumer and obtain a credit history report for the same consumer whose wallet-type data matches the credit header data.

In some cases, a consumer who provides identification information may not be authenticated and a corresponding credit history not provided by the credit bureau. This may occur, for example, because the consumer provides a nickname, an incorrect name or a name contraction rather than a proper name, and search algorithms (i.e., rules that match the consumer data against the credit database data) will be inadequate, as these algorithms do not check for a combination of names within the credit header data. As a result, business entities who request these credit reports will be provided with a “no-record” (i.e., lack of information for the given consumer name), and will not be able to ascertain the “true” credit-worthiness of a given consumer. As such, these business entities may have to make a decision based on a lack of credit information. In other cases, the credit bureau will deliver back a credit report that provides the very minimum information on a consumer (i.e., a “thin file”), which in most cases is only a single credit history file. This may occur when a credit bureau contains multiple files stored and identified by credit header data (i.e., fragmented file records) on the same consumer under different wallet-type data. Thus, when a particular type of wallet-type data is provided, the database will only extract its corresponding credit file.

In other cases, a consumer who supplies fraudulent information may not be authenticated. This may occur when the search algorithms within credit bureaus cannot match the fraudulent information to the existing header data.

Yet further, in other cases, the wallet type data supplied to the credit bureau database may either be incomplete or contain inaccurate information (either provided intentionally or unintentionally) for the consumer, and the credit bureau is not able to provide a credit history report for the particular consumer whose information is requested. This occurs, for example, when the wallet-type data submitted is missing a middle initial in a consumer name, with the credit header data containing the middle initial. Financial or business entities respond to this lack of information that they receive from the credit bureau by submitting the same data set to other databases (i.e., databases located in other credit bureaus) in the hope of obtaining, perhaps, a more complete consumer credit history. Yet again, the second credit bureau may respond with either a no-record or the same inadequate credit report.

There is therefore a need for a system and method that overcomes some or all of the previously delineated drawbacks of prior authentication system and methods, and which provides a system and method for providing alternate identifying information for a consumer in a consumer database.

### SUMMARY OF THE INVENTION

An object of the present invention is to overcome these and other drawbacks of identifying consumers in a credit bureau database.

Another object of the present invention is to provide an expanded ID file, for a consumer, back to a client entity based on reported historical data in a credit bureau database.

Another object of the present invention is to increase the amount of available information for verification and authentication of consumer data residing on credit bureau databases.

Another object of the present invention is to identify duplicate data residing on credit bureau databases.

Another object of the present invention is to identify fragmented files residing on credit bureau databases.

Another object of the present invention is to identify fraudulent activity by updating data residing in credit bureau databases and simultaneously increase the amount of information available for verification.

In a first non-limiting aspect of the present invention, a system for providing alternative identifying information for a consumer in a consumer database provided by a third party is disclosed and includes an applications server in electronic communication with a client server for receiving a request for consumer data; the applications server in communication with at least one records database for receiving information associated with the consumer;

a computing system in electronic communication with the applications server, the computing system includes a computer scoring algorithm for linking the information with the request for consumer data, wherein the linking information further comprising a new data set for the consumer.

In a second non-limiting aspect of the present invention, a computer implemented method of providing alternate indentifying information for a consumer in a third party database is provided and comprises receiving, via an applications server, a request for an expanded header file, the request including information for at least one consumer; receiving, via an applications server in communication with a communications module, a plurality of consumer records; creating, via a processing module, a plurality of first and second consumer files, wherein the first consumer file includes a first header data, and wherein the second consumer file includes second header data; matching, via a computer scoring algorithm in communication with a processing module, the first header data in the first consumer file with the second header data in the second consumer file; creating, via a processing module, expanded header data, wherein the expanded header data is a combination of header data in the first consumer file and the second consumer file, and wherein the expanded header data is dissimilar to the first consumer file and further is dissimilar to the second consumer file, thereby providing alternate identifying information for a consumer.

In a third non-limiting aspect of the present invention, a system for providing alternative identifying information for a consumer in a consumer database provided by a third party comprising an applications server in electronic communication with a client server for receiving consumer data, wherein the consumer data includes a plurality of header information; an applications database in communication with at least one records database via the applications server for storing information associated with the consumer; and a computing system in electronic communication with the applications database and the application server, the computing system includes a computer scoring algorithm for linking the consumer data with the information on the application database, wherein the computer scoring algorithm includes a plurality of rules governing a frequency of usage of the plurality of header information, wherein the linking consumer data further includes a new data set for the consumer, wherein the new data set comprises a combination of fragmented data in the at least one records database, and wherein the computing system includes a communications module in communication with the applications server.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems and methods for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 illustrates a block diagram of an overall network system according to the preferred embodiment of the invention for providing alternate identifying information.

FIG. 2 is a flowchart which illustrates an overall process of creating a new ID data set for providing alternate identifying information.

FIG. 3 illustrates a block diagram of the detailed computing system which was shown in FIG. 1.

FIG. 4 illustrates a block diagram of the system in another aspect

### DETAILED DESCRIPTION

The present invention may be understood more readily by reference to the following detailed description of preferred embodiment of the invention. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. It must be noted that, as used in the specification and the appended claims, the singular forms “a”, “an”, and “the” include plural referents unless the context clearly indicates otherwise.

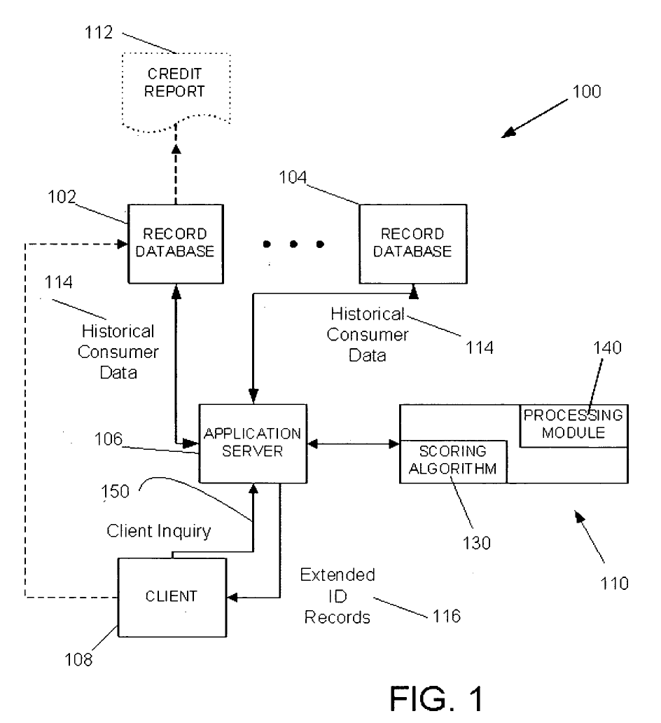

Referring now to FIG. 1, there is shown a network diagram of the overall extended ID system 100 of the preferred embodiment, system 100 includes an application server 106 in communication with a client device 108 over a physical transmission link 150, although in other non-limiting embodiments, a wireless link may be utilized. Transmission link 150 may be, in one non-limiting embodiment, an internet connection, although in other embodiments, a server access, an intranet connection, a T1 or T3 digital line, an ISDN digital line, LAN connection, a Wide Area Network, Ethernet, DSL connection or other wired or wireless connection may be utilized. Further, application server 106 preferably contains internet server software (e.g., Internet Security and Acceleration Server software manufactured by Microsoft™ and available on www.microsoft.com) communicating with a browser application resident on client device 108. Also, client device 108 may be a personal computer or workstation communicating with application server 106 across transmission link 150 to transmit wallet-type data (such as name, address, phone number, social security number, driver's license, and other common personal information) to application server 106, and this information is supplied to computing system 110 in a standard data format, by client device 108. In one non-limiting embodiment, application server 106 may be operated by an online vendor, such as a brokerage firm, financial bank, mortgage lender or other similar type of financial entity, and serves as a conduit between client device 108 and computing system 110. It should be appreciated that this invention is not limited to the internet server software manufactured by Microsoft and any other similar internet server software may be utilized without departing from the spirit of the invention.

Yet further, extended ID system 100 includes a plurality of record databases 102 and 104, which communicate with computing system 110 through application server 106. Particularly, plurality of record databases 102 and 104 may comprise, in one non-limiting embodiment, any of the following sources of data records: credit bureaus, customer files, national change of address database, commercial demographic database or other similar type of credit reporting agencies and government agencies. Computing system 110 may receive data records from database 102 and 104 and this data may comprise the entire historical consumer data 114 available for all consumers. It should be appreciated that the historical consumer data 114 may include available consumer data for all reported dates, for all reported names, for all reported addresses, for all reported social security numbers, for all reported date of births, for all reported phones, or any similar type of data record.

Computing system 110 may utilize the data records from records database 102 and 104 to extract header data (i.e., consumer files by a particular wallet-type data), such as header data files (not shown), with header data files (not shown) representing identification information sorted by an individual consumer. Computing system 110 communicates with application server 106 and may receive historical consumer data files 114 from application server 106 to be processed by computing system 110.

Computing system 110 transmits processed information by communicating with client 108 over physical transmission link 150 and transfers expanded ID set 116 (i.e., extended ID records) through application server 106, to transmit expanded ID set to client 108, although in other non-limiting embodiments, expanded ID set 116 may be transmitted directly to credit databases 102 and 104, which utilize the expanded ID set 116 to process a credit history file, for a consumer, identified by the expanded ID set 116. Thus, expanded ID set 116 eliminates and identifies fraudulent activity by updating the credit bureau databases by providing more comprehensive data, thereby simultaneously increasing the amount of information available for verification by client 208.

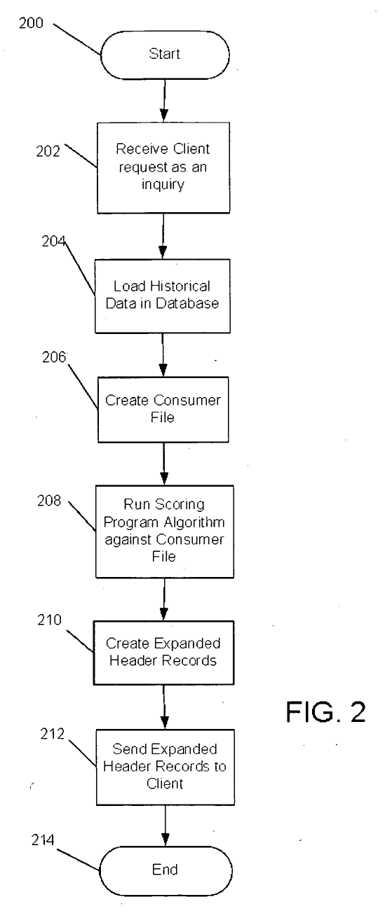

FIG. 2 shows a flowchart which describes the overall method of providing an expanded ID set 116 according to the invention. The method begins in step 200, and is followed by step 202 where an inquiry is received from client device 108. In one non-limiting embodiment, client device 108 may be a business entity, although any other type of entity (for example, a financial entity) requiring credit history on a consumer may submit the inquiry. Client device 108 submits, preferably, wallet-type information (i.e., information such as name, address, driver's license or other information commonly carried on the person).

In other non-limiting embodiments, this inquiry may be a consumer credit report that has failed to provide any information on the consumer or may even be incomplete. Step 202 is followed by step 204 where consumer historical data is received by computing server 110 and stored in an Applications database (not shown). Next, in step 206, computing system 110 creates a consumer file by an individual consumer, and creates records identifying historical data by consumer. Next, in step 208, a computing algorithm processes the consumer file to identify the frequency, recency and sources of identifying criteria for a consumer. These identifying criteria may include names, addresses and social security numbers, although in other no-limiting embodiments, additional wallet-type data may be selected. Next in step 210, the computing system 110 creates an expanded ID 116 set by a given consumer. Step 210 is followed by step 212 where the expanded ID set 116 is transmitted to the client device 108 for further processing by the client device 108. The method ends in step 214.

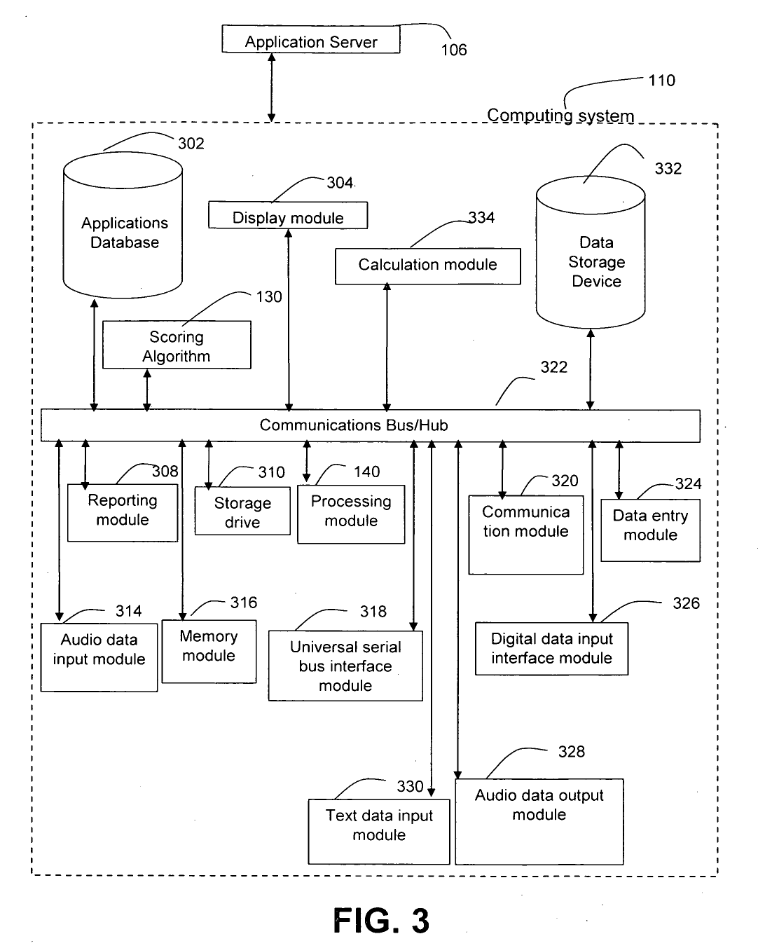

Now referring to FIG. 3, a representative block diagram of the computing system 110 is illustrated on which the methods described above may be implemented. The present invention relates to a system for providing extended identifying information, and discloses a novel method of providing an extended ID file to identify a consumer in a consumer database. The computing system 110 may include at least one central processing computer or computer network server. Computing system 110 may include a processing module 140 having at least one controller or central processing unit (CPU or processor), a communications module 320 controlling at least one communications port or hub 322, a memory module 316 having at least one random access memory (RAM) and/or at least one read-only memory (ROM) and one or more data storage modules 302, 310 and 322 having databases or data storage devices. All of these later elements are in communication with the processing module 140 to facilitate the operation of the computing system 110. The computing system 110 may be configured in many different ways. For example, computing system 110 may be a conventional standalone server computer or alternatively, the function of server may be distributed across multiple computing systems and architectures.

Computing system 110 may also be configured in a distributed architecture, wherein databases and processors are housed in separate units or locations. Some such servers perform primary processing functions and contain at a minimum, a RAM, a ROM, and a general controller or processor. In such an embodiment, each of these servers is attached to a communications hub or port 322 that serves as a primary communication link with other servers, client or user computers and other related devices. The communications hub or port 322 may have minimal processing capability itself, serving primarily as a communications router. A variety of communications protocols may be part of the system, including but not limited to: Ethernet, SAP, SAS®, ATP®, Bluetooth®, GSM® and TCP/IP.

Data storage modules 302, 310 and 332 may include a hard magnetic disk drive, optical storage units, CD-ROM drives, RAM, ROM or flash memory, and these modules 302, 310 and 332 contain databases, such as applications database 302, and are used in storing historical information for all consumers in accordance with the present invention, including at least record databases 102 and 104. In one embodiment, database software creates and manages these record databases 102 and 104. Data comparison related calculations and/or algorithms, such as scoring algorithm 130, of the present invention are stored in storage drive 310 and executed by the CPU.

The processing module 140 processes information through a controller which includes a processor, such as one or more conventional microprocessors and one or more supplementary co-processors such as math co-processors. The processor is in communication with a communication port through which the processor communicates with other devices such as other servers, user terminals or devices. The communications port 322 may include multiple communication channels for simultaneous communication with, for example, other processors, servers or client terminals. As stated, devices in communication with each other need not be continually transmitting to each other. On the contrary, such devices need only transmit to each other as necessary, may actually refrain from exchanging data most of the time and may require several steps to be performed to establish a communication link between the devices.

The processing module 140 also is in communication with data storage modules 302, 310 and 332. The data storage modules 302, 310 and 332 may include an appropriate combination of magnetic, optical and/or semiconductor memory, and may include, for example, RAM, ROM, flash drive, an optical disc such as a compact disc and/or a hard disk or drive. The processing module 140 and the data storage modules 302, 310 and 332 each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wire line medium or combination of the foregoing.

The data storage modules 302, 310 and 332 may store, for example, (i) a scoring algorithm 130 (e.g., computer program code and/or a computer program product) adapted to direct the controller in accordance with the present invention, and particularly in accordance with the processes described in detail hereinafter with regard to the controller; (ii) at least a database adapted to store information that may be utilized to store information required by the scoring algorithm 130. The database includes multiple records; each record includes fields that are specific to the present invention such as consumer name, consumer social security number, date of birth, phone number, sources, etc.

The scoring algorithm 130 may be stored, for example, in a compressed, an uncompiled and/or an encrypted format, and may include computer program code. The instructions of the scoring algorithm 130 may be read into a main memory of the processor from a computer-readable medium other than the data storage modules 302, 310 and 332, such as from a ROM or from a RAM. While execution of sequences of instructions in the scoring algorithm 130 causes the processor to perform the process steps described herein, hard-wired circuitry may be used in place of, or in combination with, software instructions for implementation of the processes of the present invention. Thus, embodiments of the present invention are not limited to any specific combination of hardware and software. Suitable computer program code may be provided for performing numerous functions such as verifying that data has been received by the data storage modules 301, 310 and 332, verifying that reports have been processed by the reporting module 308, as well as to perform any other processes not specifically assigned to any other module within the computing system 110. The functions described above are merely exemplary and should not be considered exhaustive of the type of function, which may be performed by the computer program code of the present inventions.

The computer program code required to implement the above functions (and the other functions described herein) can be developed by a person of ordinary skill in the art, and is not described in detail herein.

All of the modules described herein are operably inter-connected via a bi-directional connection with a central communications hub or bus 322. The communications hub 322 serves to receive information from every single module, as well as to transmit information from one module to another. The applications server 106 transmits and receives data, to and from the computing system 110 via any standard means known in the art. The communications modules 302, 310 and 332 transmit and receive data, to and from the computing system 110 via any standard electronic means known in the art. The computing system 110 consists of a display module 304 and a data entry module 324.

Additionally, computing system 110 includes a computer scoring algorithm 130 for further comparing plurality of consumer files and identifying all ID variations (i.e., variations in data records by consumer) while all matching header data is tagged under the same consumer identification number (“Consumer ID”) and compiled in an expanded header file 116. It should be appreciated that a Consumer ID may contain variations of header information either supplied by consumers or supplied by records database 102 and 104. This functions to allow system 100 to identify credit history data for General ID set (i.e., standard records that identify an individual by name, social security number and date of birth, or similar types of personal data) that may not normally provide a credit history. In one non-limiting embodiment, variations of records may include frequency of names, although, in other embodiments, variations of records may include recency of names, sources of names, frequency of addresses, recency of addresses, sources of addresses, or other similar types of data.

Computer scoring algorithm 130, residing within Computing system 110, may include a set of rules to link consumer IDs, in one non-limiting embodiment, by a particular frequency of name usage. The result is that computer scoring algorithm 130 creates a expanded header set (i.e., data records which comprises the highest probability of name, address, and social security number combination), for a given consumer that comprises a single modified name, rather than a series of names in header data which is traditionally used.

In addition, the computing system 110 includes a reporting module 308. The reporting module 308 may be used for producing reports of information associated with providing an extended ID record 116, as well as any other kinds of related reports.

The application database 302 may be internal to the computing system 110, for the purposes of allowing further controls of data access, to be implemented if needed. However, a data storage device 332, which may be external to the computing system 110, may be used without departing from the spirit of the present invention. It should be appreciated that data storage modules 302, 310 and 332 may be relational databases, or any similar type of database structure comprising tables of rows and columns.

Additionally, the computing system 110 includes a text data input module 330 for inputting data in the form of text and a data entry module 324 for entering a variety of forms of data and inputting the data into the computing system 210.

Finally, the computing system 110 includes an audio data input module 314 for receiving and inputting audio information, a calculation module 334 for performing any necessary mathematical calculations, a memory module 316 for temporarily storing information as it is being processed by the processing module 140, a universal serial bus interface module 318 for receiving and transmitting data to and from devices capable of establishing a universal serial bus connection and a digital data input interface module 326 for receiving data contained in digital storage devices (e.g. floppy disk, zip drive, 8 mm digital tape, etc).

The term “computer-readable medium” as used herein refers to any medium that provides or participates in providing instructions to the processor of the computing device (or any other processor of a device described herein) for execution. Such a medium may take many forms, including but not limited to, non-volatile media, volatile media and transmission media. Non-volatile media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Computing system 110 of the present invention may also interact and/or control one or more user devices or terminals 108. The user device or terminal 108 may include any one or a combination of a personal computer, a mouse, a keyboard, a computer display, a touch screen, LCD, voice recognition software or other generally represented by input/output devices required to implement the above functionality. The program also may include program elements such as an operating system, a database management system and “device drivers” that allow the processor to interface with computer peripheral devices (e.g., a video display, a keyboard, a computer mouse, etc).

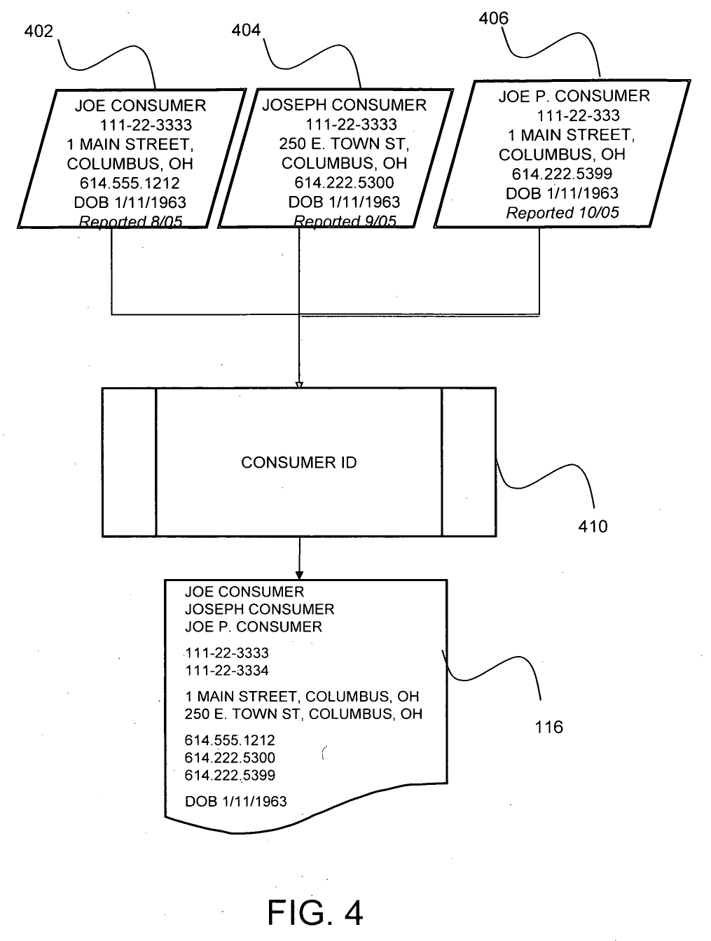

As an illustration, FIG. 4 shows consumer header data files 402, 404 and 406 processed by computing system 110 in order to provide expanded ID records 116. Particularly, consumer files 402, 404 and 406 may represent the same consumer, and rules within computer scoring algorithm 130 tag files 402, 404 and 406 with the same consumer ID 410 by matching the social security number in each consumer file. This functions to allow system 100 to identify consumers that have fragmented data in consumer files 402, 404 and 406, and subsequently causes these consumers to be identifiable when a credit history report is created. The tagged consumer ID 410 information is processed and combined to create an expanded ID file 116 that includes more variations in, as an example, a consumer name, although this expanded ID file may include, in addition, variations in phone number, or other similar type of wallet-type data. Therefore, the system 100 identifies fragmented files (which may represent duplicate and/or erroneous data) represented by consumer files 420, 404 and 406 residing on credit databases 102 and 104.

Thus, this invention is not limited to the disclosed features and other similar method and system may be utilized without departing from the spirit of the present invention.

While the present invention has been described with reference to the preferred embodiment and alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A system for providing alternative identifying information for a consumer in a consumer database provided by a third party comprising:
an applications server in electronic communication with a client server for receiving consumer data;
an application database in communication with at least one records database via said applications server for storing information associated with said consumer;
a computing system in electronic communication with said application database and said application server, said computing system includes a computer scoring algorithm for linking said consumer data with said information on said application database, wherein said linking information further includes a new data set for said consumer.

2. The system of claim 1, wherein said new data set includes a combination of fragmented data in said at least one records database.

3. The system of claim 1, wherein said new data set includes a combination of no-record data in said at least one records database.

4. The system of claim 1 wherein said computing system includes a communications module in communication with said applications server.

5. The system of claim 1 further comprising an applications database in communication with said computer scoring algorithm.

6. The system of claim 1 wherein said consumer data has a plurality of header information.

7. The system of claim 6 wherein said computer scoring algorithm has a plurality of rules governing a frequency of usage of said plurality of header information.

8. The system of claim 1 wherein said scoring algorithm includes at least one rule for matching said consumer data to data on said application database.

9. The system of claim 1 wherein said linking information includes a highest probability of data in said applications database selected from the group consisting of: name, address and social security number.

10. A computer implemented method of providing alternate identifying information for a consumer in a third party database, the method comprising:
receiving, via an applications server, a request for an expanded header file, the request including information for at least one consumer;
receiving, via an applications server in communication with a communications module, a plurality of consumer records;
creating, via a processing module, a plurality of first and second consumer files, wherein the first consumer file includes a first header data, and wherein the second consumer file includes second header data;
matching, via a computer scoring algorithm in communication with a processing module, the first header data in the first consumer file with the second header data in the second consumer file;
creating, via a processing module, expanded header data, wherein the expanded header data is a combination of header data in the first consumer file and the second consumer file, and wherein the expanded header data has at least one item of data from the first consumer file and wherein the expanded header data has at least one item of data from the second consumer file, thereby providing alternate identifying information for a consumer.

11. The computer implemented method of claim 10, wherein the computer scoring algorithm includes a plurality of rules governing when different header information is most often used.

12. The computer implemented method of claim 11, wherein the scoring computer scoring algorithm includes at least one rule for matching the first and the second consumer file by frequency of names used.

13. The computer implemented method of claim 12, wherein the scoring algorithm includes at least one rule for matching the first and the second consumer file by frequency of addresses used.

14. The computer implemented method of claim 13, wherein the expanded header file includes a highest probability of data in the first consumer file and the second consumer file selected from the group consisting of: name, address and social security number.

15. A system for providing alternative identifying information for a consumer in a consumer database provided by a third party comprising:
an applications server in electronic communication with a client server for receiving consumer data, wherein said consumer data includes a plurality of header information;
an applications database in communication with at least one records database via said applications server for storing information associated with said consumer; and
a computing system in electronic communication with said application database and said application server, said computing system includes a computer scoring algorithm for linking said consumer data with said information on said application database,
wherein said computer scoring algorithm includes a plurality of rules governing a frequency of usage of said plurality of header information,
wherein said linking consumer data further includes a new data set for said consumer,
and wherein said computing system includes a communications module in communication with said applications server.

16. The system of claim 15 wherein said new data set comprises a combination of fragmented data in said at least one records database.

17. The system of claim 15 wherein said new data set comprises a combination of no-record data in said at least one records database.
